(19) United States
(12) Patent Application Publication
(10) Pub. No.: US 2020/0267911 A1
(43) Pub. Date: Aug. 27, 2020

(54) FULL-AUTOMATIC SYSTEM OF INTEGRATED SORTING-TRANSPLANTING-REPLANTING AND OPERATION METHOD FOR PLUG SEEDLINGS

(71) Applicant: JIANGSU UNIVERSITY, Zhenjiang, Jiangsu (CN)

(72) Inventors: Jizhan Liu, Zhenjiang, Jiangsu (CN); Xin Zhou, Zhenjiang, Jiangsu (CN)

(21) Appl. No.: 16/334,453

(22) PCT Filed: Nov. 15, 2017
(86) PCT No.: PCT/CN2017/110975

§ 371 Date: Mar. 19, 2019

(30) Foreign Application Priority Data
Sep. 18, 2017 (CN) 201710841824.5

(51) Int. Cl. A01G 9/08; A01C 11/02

(52) U.S. Cl. CPC A01G 9/083; A01C 11/025; A01G 9/086

(57) ABSTRACT

A full-automatic system and operation method of integrated sorting-transplanting-replanting for plug seedlings includes a frame, feeding units for a target tray and source tray, a discarding seedling tray bin, a single-claw for replanting unit, a multi-claw for sorting and transplanting unit, seedling picking claws and a monitoring module. During transportation, the seedling picking claws pass through a seedling picking zone, seedling monitoring zone, seedling discarding zone and seedling releasing zone in turn. The monitoring module and the single-claw for replanting unit are located behind and in the front of the vertical movement plane of the multi-claw, respectively. Along a tray feeding direction, a first row of the source tray is set as a source area for replanting, and other rows of the source tray are all set as the source area for transplanting. The monitoring and sorting is finished during the transportation without stopping.

### TECHNOLOGY SCOPE

This invention patent is related to the scope of agricultural equipment, in particular to an integrated sorting-transplanting-replanting and operation method for plug seedlings.

### TECHNOLOGY BACKGROUND

Industrial seedling rearing must be transplanted from high density tray to low density tray once or several times and the bad and weak seedlings will be replaced for uniform and strong cultivate of seedlings. At present, mass of sorting-transplanting and replanting for seedlings tray are realized by manual, which occupy a large amount of labor and consume a lot of time and energy, so that the automatic transplanting and replanting have been an urgent need for the development of industrial seedling rearing.

Aiming to automatic sorting—transplanting and replanting for seedlings, scholars at home and abroad have studied many years and investigated a lot of effective results, Visser in Netherlands, TTA in American, Filer in Netherlands and other companies have launched automatic transplanting machine products equipped with visual monitoring system. Because of the independence on the transplanting system, monitoring and sorting system, replanting system, major shortcomings are caused as followings:

(1) The system is complex and huge, which requires high equipment investment and a large workspace to complete transplanting in row, unhealthiness seedlings monitoring, absence of unhealthiness seedling and vacancy hole tray replanting.

(2) It needs to transplant to target tray after seedlings picking in row, unhealthiness seedlings monitoring, picking out and discarding, and unhealthiness seedling monitoring is carried out in target tray statically, and unhealthiness seedling discarding, healthy seedling transplanting, and replanting for vacancy tray are all need to operate in turns, and exist that repetitive operations of seedlings planting and picking-releasing to result lengthy operation process complex.

Although automatic and efficient transplanting has been widely applied in developed countries, the application and extension rate of automatic sorting-replanting is still very low, the key restrict is the complexity and inefficiency of sorting-transplanting-replanting system.

In addition, parallel transplanting robot has been studied to monitoring, sorting, transplanting and replanting in turn, because of the low efficiency so that it is not suitable for large-scale operation, and it is still limited to research and does not applied in the production field.

### SUMMARY OF INVENTION

In view of the shortcomings of existing automatic sorting, transplanting and replanting technology and equipment for seedlings, this invention aims to provide a full-automatic system of integrated sorting-transplanting-replanting and operation method for plug seedlings to realize the high efficiency integrated operation of seedling sorting-transplanting-replanting automatically.

In order to solve the technical problems above, specific technical scheme of this invention is taken as followings:

Full-automatic system of integrated sorting-transplanting-replanting and operation method for plug seedlings is characterized that it is consisted of the frame (3), the feeding units for target tray (1) and source tray (8), the discarding seedling tray bin (2), the single-claw for replanting unit (4), the multi-claw for sorting and transplanting unit (5), the seedling picking claw (6), the monitoring module (7);

the monitoring module (7) and the discarding seedling tray bin (2) are installed between the feeding units for source tray (8) and the feeding units for target tray (1). And the monitoring module (7) is closed to the feeding units for source tray (8), the discarding seedling tray bin (2) is closed to the feeding units for target tray (1);

along to the feeding direction v, the monitoring module (7) is located behind the multi-claw for sorting and transplanting unit (5), the single-claw for replanting unit (4) is located in front of the multi-claw for sorting and transplanting unit (5).

Holes in the tray of first row along to the feeding direction v for the source tray 10 are used as the source area for single-claw replanting F; the holes in the tray of other rows along to the feeding direction v for source tray 10 are used as source area for multi-claw transplanting G. Full-automatic system of integrated sorting-transplanting-replanting and operation method for plug seedlings can be characterized as the following action steps:

Step 1: The multi-claw for sorting and transplanting unit (5) drives k the seedling picking claws (6) to pick k seedlings from the first row of the source area for multi-claw transplanting (G) along the feeding direction v of the source tray (10).

Step 2: Driven by the multi-claw for sorting and transplanting unit (5), k seedling picking claws (6) grip k seedlings to move along the transportation route (E) in the vertical movement plane of multi-claw (H). When the k seedlings gripped by k seedling picking claws (6) pass the seedling monitoring zone (B) firstly, the monitoring module (7) monitor the k seedlings to detect all the non-ideal conditions, including the absence of seedling lump (12), the damage of seedling lump (12), the absence of seedling plant (11), the unhealthiness of seedling plant (11) and the damage of seedling plant (11) successively.

Step 3: Driven by the multi-claw for sorting and transplanting unit (5), k seedling picking claws (6) grip k seedlings to move further along the transportation route (E) in the vertical movement plane of multi-claw (H). When k seedlings gripped by k seedling picking claws (6) pass the seedling discarding zone (C), the detected seedlings which have any of the above-mentioned non-ideal conditions will be discarded in the discarding seedling tray bin (2). As a result, the non-stop sorting and transplanting of multiple seedlings is realized.

Step 4: Driven by the multi-claw for sorting and transplanting unit (5), k seedling picking claws (6) grip k seedlings to move further along the transportation route (E) in the vertical movement plane of multi-claw (H). When k seedlings gripped by k seedling picking claws (6) pass the seedling releasing zone (D), the multi-claw for sorting and transplanting unit (5) drives k seedling picking claws (6) to finish the placing of k seedlings to the target tray (9). Since the number of rows (m1) of the source tray (10) and the number of rows (m2) of the target tray (9) are both integral times of the number of seedling picking claws (6), m2×n2/k times of placing is needed to fill all the holes (row m1×line n2) of the target tray (9).

Step 5: In each cycle of the multi-claw transplanting, missing of seedlings in holes of the target tray (9) will happen when there is any above-mentioned non-ideal conditions for seedlings gripped by k seedling picking claws (6). According to the monitoring results of the monitoring module (7), the serial numbers of tray holes for the target tray (9) will be obtained.

Step 6: In the meantime of multi-claw for sorting and transplanting drive k seedling picking claws (6) to operate multi-claw transplanting, the single-claw for replanting unit (4) picks seedlings from the source area for single-claw replanting (F) to replant them into the tray holes that miss seedlings, according to the serial numbers of tray holes obtained from the target tray (9).

Beneficial Effects of the Invention Patent:

This patent achieve the transplanting the plug seedlings in row, sorting and monitoring without stop, planting and replanting randomly, all-in one integration and effectively avoid the complex and inefficient defects of the sorting and transplanting system and greatly improving the ability of the monitoring and sorting and replanting for the multi-claw sorting system at the same time, by the process of monitoring and sorting without stop, the multi-claw sorting and the single-claw replanting in the same plate partition for seedlings and master-slave cooperation, without changing the base of the main structure and flow for multi-claw transplanting system.

### DESCRIPTION OF FIGURES

FIG. 1 is the schematic diagram of overall structure of the full-automatic system of integrated sorting-transplanting-replanting.

FIG. 2 is the horizontal layout of overall structure of the full-automatic system of integrated sorting-transplanting-replanting.

FIG. 3 is the layout diagram of the overall structure of the full-automatic system of integrated sorting-transplanting-replanting in the vertical plane H.

FIG. 4 is the block diagram of the source tray.

FIG. 5 is the schematic diagram of seedling structure.

NOTES: 1. feeding units for target tray, 2. discarding seedling tray bin, 3. frame, 4. single-claw for replanting unit, 5. multi-claw for sorting and transplanting unit, 6. seedling picking claws, 7. monitoring module, 8. feeding units for source tray, 9. target tray, 10. source tray, 11. seedling plant, 12. seedling lump, A. seedling picking zone, B. seedling monitoring zone, C. seedling discarding zone, D. seedling releasing zone, E. transportation route, F. source area for single-claw replanting, G. source area for multi-claw transplanting, H. vertical movement plane of multi-claw, v. feeding direction.

Specific Implementation Methods:

Technical scheme of the present invention is described in further details with connection to the figures and specific embodiments.

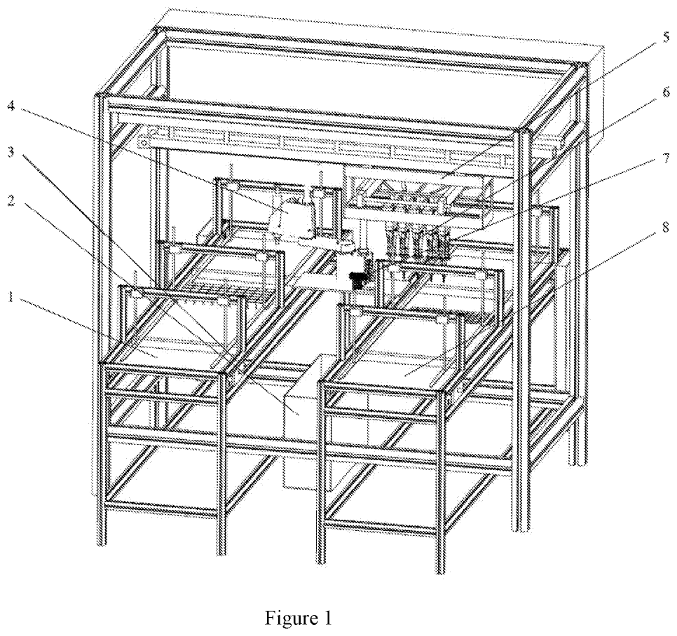

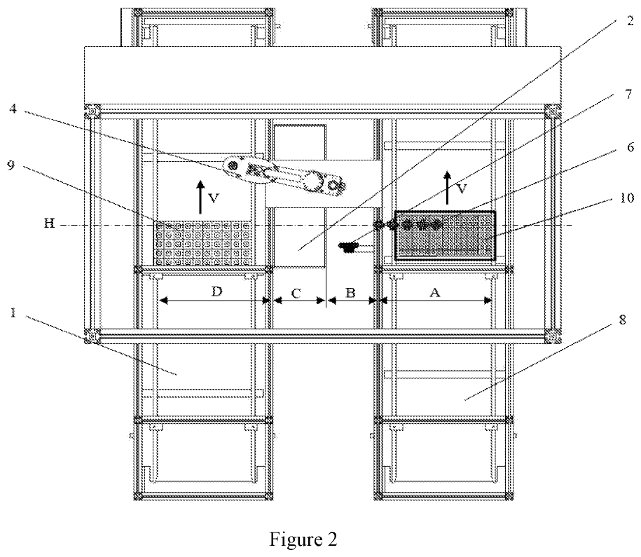

As shown in FIG. 1 and FIG. 2, full-automatic system of integrated sorting-transplanting-replanting and operation method for plug seedlings is consisted of the frame 3, the feeding units for target tray 1 and source tray 8, the discarding seedling tray bin 2, the single-claw for replanting unit 4, the multi-claw for sorting and transplanting unit 5, the seedling picking claws 6, the monitoring module 7. The feeding units for source tray 8 and the feeding units for target tray 1 are fixed parallel to the frame 3, and realized the source tray 10 and the target tray 9 feeding in the same direction along feeding direction v. The source tray 10 has row (m₁)×line (n₁) holes, the distance among every tray is p₁; the target tray 9 has row (m₂)×line (n₂) holes, the distance among every tray is p₂. The source tray 10 is horizontally fixed on the conveying surface of the feeding units for source tray 8 by compression bar, the target tray 9 is horizontally fixed on the conveying surface of the feeding units for target tray 1 by compression bar, while the row of the source tray 10 and the target tray 9 are all parallel to the feeding direction v.

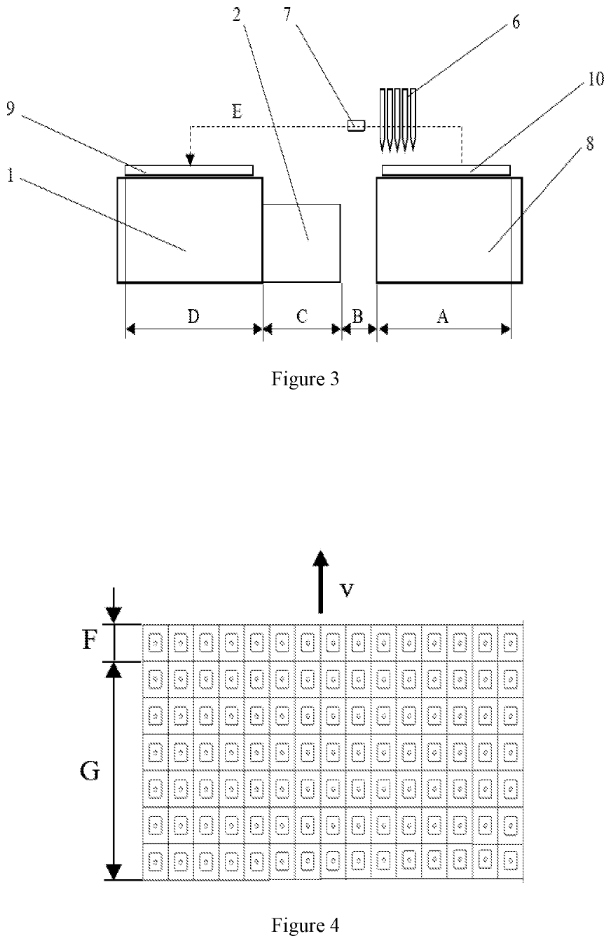

As shown in FIG. 1, FIG. 2 and FIG. 3, k the seedling picking claws 6 are installed under the multi-claw for sorting and transplanting unit 5, k seedling picking claws 6 are arranged in horizontal straight line perpendicular to the feeding direction v, the number of rows (m₁) of the source tray 10 and the number of rows (m₂) of the target tray 9 are both integral times of the number of seedling picking claws 6. The vertical liner movement unit of multi-claw for sorting and transplanting unit 5 drives k seedling picking claws 6 moving vertically, the horizontal liner movement unit of multi-claw for sorting and transplanting unit 5 drives k seedling picking claws 6 moving horizontally above the feeding units for the source tray 8 and the feeding units target tray 1, during the horizontally movement of k seedling picking claws 6, the expansion unit in multi-claw for sorting and transplanting unit 5 drive the center distance of seedling picking claws 6 adjacent changed the hole distance p1 of the source tray 10 to the hole distance p2 of the target tray 9. The transportation route E is constituted of the vertical and horizontal movement of seedling picking claws 6, the transportation route E is located in the vertical movement plane of multi-claw H.

As shown in FIG. 2 and FIG. 3, during the horizontal lateral transfer process of k seedling picking claws 6 grip seedlings from the source tray 10 to the target tray 9, and go through the seedling picking zone A, seedling monitoring zone B, seedling discarding zone C and seedling releasing zone D, the source tray 10 of the feeding units for source tray 8 is located in the seedling picking zone A, the monitoring module 7 is located in the seedling monitoring zone B, the discarding seedling tray bin 2 is located in seedling discarding zone C, the target tray 9 of feeding unit for target tray 1 is located in the seedling releasing zone D.

As shown in FIG. 2 and FIG. 3, along to the feeding direction v, the monitoring module 7 is located behind the vertical movement plane of multi-claw H, the center of k seedling picking claws 6 are located in the vertical movement plane of multi-claw H, the base of single-claw for replanting unit 4 is located in front of the vertical movement plane of multi-claw H.

As shown in FIG. 4, tray hole in first row the source tray 10 along to the feeding direction v is used as source area for single-claw replanting F; the hole in the tray of the source tray 10 except first row along to the feeding direction v is used as the source area for multi-claw transplanting G.

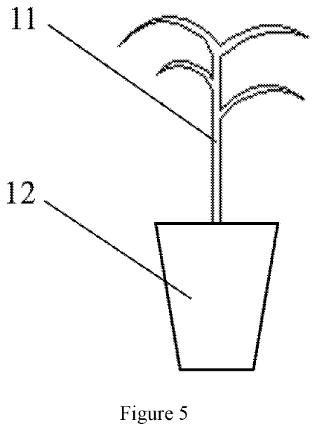

As shown in FIG. 5, every plug seedling is consisted of the seedling plant 11 and the seedling lump 12.

By using the invention that full-automatic system of integrated sorting-transplanting-replanting to realize automatic system of integrated sorting-transplanting-replanting operation are as followings:

(1) The multi-claw for sorting and transplanting unit 5 drives k the seedling picking claws 6 to pick k seedlings from the first row of the source area for multi-claw transplanting G along the feeding direction v of the source tray 10.

(2) Driven by the multi-claw for sorting and transplanting unit 5, k seedling picking claws 6 grip k seedlings to move along the transportation route E in the vertical movement plane of multi-claw H. When the k seedlings gripped by k seedling picking claws 6 pass the seedling monitoring zone B firstly, the monitoring module 7 monitor the k seedlings to detect all the non-ideal conditions, including the absence of seedling lump 12, the damage of seedling lump 12, the absence of seedling plant 11, the unhealthiness of seedling plant 11 and the damage of seedling plant 11 successively.

(3) Driven by the multi-claw for sorting and transplanting unit 5, k seedling picking claws 6 grip k seedlings to move further along the transportation route E in the vertical movement plane of multi-claw H. When k seedlings gripped by k seedling picking claws 6 pass the seedling discarding zone C, the detected seedlings which have any of the above-mentioned non-ideal conditions will be discarded in the discarding seedling tray bin 2. As a result, the non-stop sorting and transplanting of multiple seedlings is realized.

(4) Driven by the multi-claw for sorting and transplanting unit 5, k seedling picking claws 6 grip k seedlings to move further along the transportation route E in the vertical movement plane of multi-claw H. When k seedlings gripped by k seedling picking claws 6 pass the seedling releasing zone D, the multi-claw for sorting and transplanting unit 5 drives k seedling picking claws 6 to finish the placing of k seedlings to the target tray 9. Since the number of rows (m₁) of the source tray 10 and the number of rows (m₂) of the target tray 9 are both integral times of the number of seedling picking claws 6, m₂×n₂/k times of placing is needed to fill all the holes (row m₁×line n₂) of the target tray 9.

(5) In each cycle of the multi-claw transplanting, missing of seedlings in holes of the target tray 9 will happen when there is any above-mentioned non-ideal conditions for seedlings gripped by k seedling picking claws 6. According to the monitoring results of the monitoring module 7, the serial numbers of tray holes for the target tray 9 will be obtained.

(6) In the meantime of multi-claw for sorting and transplanting drive k seedling picking claws (6) to operate multi-claw transplanting, the single-claw for replanting unit (4) picks seedlings from the source area for single-claw replanting (F) to replant them into the tray holes that miss seedlings, according to the serial numbers of tray holes obtained from the target tray (9).

1. A full-automatic system of integrated sorting-transplanting-replanting for plug seedlings comprising a frame, feeding units for a target tray and a source tray, a discarding seedling tray bin, a single-claw for replanting unit, a multi-claw for sorting and transplanting unit, seedling picking claws, and a monitoring module,
wherein the monitoring module and the discarding seedling tray bin are installed between the feeding units for the source tray and the feeding units for the target tray, the monitoring module is closed to the feeding units for the source tray, and the discarding seedling tray bin is closed to the feeding units for the target tray; and
wherein along a feeding direction-v, the monitoring module is located behind the multi-claw for sorting and transplanting unit, and the single-claw for replanting unit is located in front of the multi-claw for sorting and transplanting unit.

2. The full-automatic system of integrated sorting-transplanting-replanting for plug seedlings in accordance with claim 1, wherein along the feeding direction, a first row of the source tray is set as the source area for single-claw replanting, and other rows of the source tray are all set as the source area for multi-claw transplanting.

3. A method of operation for a full-automatic system of integrated sorting-transplanting-replanting for plug seedlings comprising a frame, feeding units for a target tray and a source tray, a discarding seedling tray bin, a single-claw for replanting unit, a multi-claw for sorting and transplanting unit, seedling picking claws, and a monitoring module, the method comprising:
the multi-claw for sorting and transplanting unit drives the seedling picking claws to pick seedlings from the first row of the source area for multi-claw transplanting along the feeding direction of the source tray;
driven by the multi-claw for sorting and transplanting unit, seedling picking claws grip seedlings to move along the transportation route in a vertical movement plane of the multi-claw and when the seedlings gripped by the seedling picking claws pass a seedling monitoring zone firstly, the monitoring module monitors the seedlings to detect all non-ideal conditions, including an absence of a seedling lump, damage to the seedling lump, an absence of a seedling plant, unhealthiness of the seedling plant and damage to the seedling plant successively;
driven by the multi-claw for sorting and transplanting unit, the seedling picking claws grip seedlings to move further along the transportation route in the vertical movement plane of multi-claw, and when seedlings gripped by the seedling picking claws pass a seedling discarding zone, the detected seedlings which have any non-ideal conditions will be discarded in the discarding seedling tray bin such that non-stop sorting and transplanting of multiple seedlings is realized;
driven by the multi-claw for sorting and transplanting unit, seedling picking claws grip seedlings to move further along the transportation route in the vertical movement plane of the multi-claw, and when seedlings gripped by the seedling picking claws pass a seedling releasing zone, the multi-claw for sorting and transplanting unit drives seedling picking claws to finish the placing of seedlings to the target tray, wherein the number of rows of the source tray and the number of rows of the target tray are both integral times of the number of seedling picking claws, such that the number of times placing is needed to fill all the holes of the target tray is the number of rows of the source tray times the number of rows of the target tray, divided by the number of seedling picking claws;
in each cycle of the multi-claw transplanting, seedlings missing holes of the target tray will happen when there is any above-mentioned non-ideal condition of the seedlings gripped by the seedling picking claws, wherein according to the monitoring results of the monitoring module, the serial numbers of tray holes for the target tray are obtained; and
while the multi-claw for sorting and transplanting drives seedling picking claws to operate multi-claw transplanting, the single-claw for replanting unit picks seedlings from the source area for single-claw replanting to replant them into the tray holes that miss seedlings, according to the serial numbers of tray holes obtained from the target tray.
